(19) United States
(12) Patent Application Publication
(10) Pub. No.: US 2024/0116755 A1
(43) Pub. Date: Apr. 11, 2024

(54) RECYCLABLE HYDROGEN PRODUCTION MATERIAL AS WELL AS PREPARATION METHOD AND USE THEREOF

(71) Applicant: HANGZHOU JIANGYONG ENERGY SAVING TECHNOLOGY CO., LTD., Zhejiang (CN)

(72) Inventor: Yong XU, Zhejiang (CN)

(73) Assignee: HANGZHOU JIANGYONG ENERGY SAVING TECHNOLOGY CO., LTD., Zhejiang (CN)

(21) Appl. No.: 18/273,267

(22) PCT Filed: Oct. 21, 2022
(86) PCT No.: PCT/CN2022/126662

§ 371 Date: Jul. 19, 2023

(30) Foreign Application Priority Data
Dec. 24, 2021 (CN) 202111602053.7

(51) Int. Cl. C01B 3/08; C09K 17/08; C09K 17/10

(52) U.S. Cl. CPC C01B 3/08; C09K 17/08; C09K 17/10; C09K 2101/00

(57) ABSTRACT

The raw materials of hydrogen production material includes: 12-17% of sodium hydroxide, 10-22% of water, 1-3% of a solid material capable of reacting with the sodium hydroxide to form an adhesive, 25-44% of a forming intermediate, and 25-40% of aluminum powder. The preparation method includes: adding the sodium hydroxide into the water, stirring for dissolving and then adding the solid material, stirring until the mixture is dissolved and then adding the forming intermediate, stirring evenly and then adding the aluminum powder, and stirring evenly to obtain forming slurry; and compacting the forming slurry for molding, and then drying to obtain the hydrogen production material. The using method includes: placing the hydrogen production material into a hydrogen collector filled with water at room temperature and atmospheric pressure, and enabling same to react so as to obtain hydrogen as well as recyclable reaction liquid and residues from the hydrogen collector.

### TECHNICAL FIELD

The present disclosure relates to the technical field of hydrogen production materials, in particular to a recyclable hydrogen production material as well as a preparation method and use thereof.

### DESCRIPTION OF RELATED ART

In recent years, with the rapid development of the national economy and the continuous improvement of living standards, the demand for energy will continue to increase. Although existing energy can meet the needs of economic operation, there are various unfavorable factors such as high production costs, high prices, pollution, limitations, and carbon dioxide emissions. Clean energy is an indispensable energy for human society in the future, in which hydrogen is a clean and sustainable energy due to its high combustion heat value and pollution-free products.

At present, the hydrogen is mainly produced by the methods such as fossil fuel reforming, water electrolysis, photohydrolysis, biological process, and plasma. However, these hydrogen production methods generally have the defects of environmental pollution, high preparation cost, and the like, thus being difficult to be industrialized on a large scale. In order to solve the above problems and achieve the effective utilization of hydrogen energy, it is proposed to produce hydrogen by reacting metal with water, such as enable magnesium or aluminum to react with water to produce hydrogen. Aluminum is abundant in the Earth's crust, and the products of a reaction between metal aluminum and water can be recycled. Therefore, using the metal aluminum, especially waste aluminum, to react with the water to produce the hydrogen can obtain a large-scale and low-cost hydrogen source. However, in actual operation, there are many problems in a reaction system for producing hydrogen from aluminum, for example, the reaction process is not easy to control, continuous hydrogen production cannot be realized, and the inconvenient storage and transportation of raw materials leads to the complexity of a reaction device.

The Chinese patent document with a publication number CN104276541A discloses a controllable hydrogen production device based on a reaction of aluminum alloy with water. The device utilizes its own pressure to carry out hydrogen generation and hydrogen production rate regulation, but cannot achieve the recycling of working fluid, resulting in a large amount of waste working fluid, which directly leads to the high cost of hydrogen production.

### SUMMARY

The present disclosure provides a recyclable hydrogen production material as well as a preparation method and use thereof for solving the problems in the prior art that a reaction system for producing hydrogen from aluminum is difficult in reaction process control and thus cannot achieve continuous hydrogen production, and the inconvenient storage and transportation of raw materials leads to the complexity of a reaction device. A forming intermediate and a solid material capable of reacting with sodium hydroxide to form an adhesive are employed as auxiliary raw materials. Aluminum powder is made into a solid with a geometric shape, and hydrogen can be naturally and continuously produced by putting the solid into water at room temperature and atmospheric pressure. The hydrogen production rate is controllable, the raw materials are easy to store and transport, and the reaction product can be recycled. Therefore, the present disclosure is safe, environment-friendly, and low in production cost, thus being suitable for large-scale industrial production.

To achieve the above purpose, the present disclosure adopts the following technical solution:

A recyclable hydrogen production material is prepared from raw materials, and the raw materials in percentage by mass comprises: 12-17% of sodium hydroxide, 10-22% of water, 1-3% of a solid material capable of reacting with the sodium hydroxide to form an adhesive, 25-44% of a forming intermediate, and 25-40% of aluminum powder.

The present disclosure also discloses a preparation method of the hydrogen production material, which includes the following steps: (1) adding the sodium hydroxide into the water, stirring for dissolving and then adding the solid material, stirring until the mixture is dissolved and then adding the forming intermediate, stirring evenly and then adding the aluminum powder, and stirring evenly to obtain forming slurry; and (2) compacting the forming slurry for molding, and then drying to obtain the hydrogen production material. The alkaline hot gas generated in the preparation process can be passed into a water storage tank for recycling.

According to the present disclosure, a forming intermediate and a solid material capable of reacting with sodium hydroxide to form an adhesive are employed as auxiliary raw materials, and aluminum powder can be made into solids of various geometric shapes. In the preparation process, the sodium hydroxide is first dissolved in water to obtain a sodium hydroxide solution, the solid material is then added into the solution and enabled to react with the sodium hydroxide to form an adhesive, and the forming intermediate is bonded with aluminum powder, so that the raw materials can be pressed and molded in a mold to form shapes such as a brick shape; and the sizes and dimensions can be selected according to needs, which is convenient for handling and storage. The hydrogen production material provided by the present disclosure can react with water to produce hydrogen at room temperature and atmospheric pressure, and the hydrogen production material is made into bricks (240 mm×115 mm×53 mm), which can continuously produce the hydrogen in water for about 48 h. Therefore, the hydrogen production material provided by the present disclosure is easy in availability of raw materials and stable in product composition and structure, and the preparation process is non-toxic and pollution-free, and does not produce irritating odor, thus being high in safety; and the hydrogen production material is easy to use, and convenient to store and transport, thus being suitable for industrial production.

In the blocky hydrogen production material prepared according to the present disclosure, the sodium hydroxide can not only react with the solid material to form the adhesive, but also avoid the formation of an oxide film caused by the oxidation of the surface of the aluminum powder, thus avoiding the occurrence of a hydrogen production reaction being affected. The forming intermediate not only plays a shaping role, which allows the aluminum powder to be pressed into geometric shapes such as bricks, but also can reduce the contact area between the aluminum powder and the water in a reaction process, thereby regulating the reaction rate of the aluminum powder and the water, and avoiding the reaction safety being affected due to the overhigh temperature in a hydrogen collector caused by the excessive reaction between the aluminum powder and the water. Moreover, during the preparation process of the present disclosure, the aluminum powder can contact with the water to generate hydrogen. The generated hydrogen can form rich pore structures in the pressed hydrogen production material, which allows the water to smoothly enter the interior of the hydrogen production material along the pore structures during use, thus avoiding the phenomenon that since the pressed hydrogen production material is too dense, the interior of the material cannot effectively contact with the water, and the utilization rate of the material is reduced accordingly. However, adding too much water in the preparation process can also lead to excessive consumption of aluminum, which will affect the hydrogen production time of the dried hydrogen production material.

Preferably, in step (2), the formed hydrogen production material is continuously turned over in a drying process. During drying, the hydrogen generated by the reaction between the aluminum powder and the water will escape from the top of the formed hydrogen production material. Therefore, in order to ensure the pore structures on both sides of the hydrogen production material to be even, the hydrogen production material needs to be continuously turned over in the drying process to ensure that all parts of the hydrogen production material can evenly contact with the water during use for production of hydrogen.

Preferably, the solid material is 3,000-mesh to 5,000-mesh hydrophilic fumed silica. According to the present disclosure, the 3,000-mesh to 5,000-mesh hydrophilic fumed silica is used as a raw material, which is cheap and easy to obtain. In addition, when being added into the hot concentrated sodium hydroxide solution, the silica can react with the sodium hydroxide to obtain a sodium silicate solution. The sodium silicate solution has good bonding performance, which can be used as the adhesive to bond the forming intermediate with the aluminum powder, so that the raw materials can be pressed and formed in the mold.

Preferably, the forming intermediate is yellow mud. The present disclosure employs the yellow mud from a mountain as the forming intermediate, which not only can play a role of molding, but also improves the forming strength of the hydrogen production material, reduces the amount of the solid material, and thus reduces the production cost due to the fact that the yellow mud is rich in silica that can also react with the sodium hydroxide to form the adhesive.

Preferably, the water is selected from one or more of water from a well, water from a mountain, and water from a river; the sodium hydroxide is industrial grade caustic soda flake; and the aluminum powder is aluminum powder waste.

As for the raw materials used in the present disclosure, the natural water such as the water from the well, the water from the mountain, and the water from the river may be employed as the water, the industrial grade caustic soda flake may be employed as the sodium hydroxide, the aluminum powder waste produced in industrial production may be employed as the aluminum powder, and the yellow mud is also the most common raw material in nature world, so that all the raw materials used in the present disclosure are wide in sources and low cost. Therefore, the present disclosure is suitable for industrial production.

The present disclosure further discloses a use of the hydrogen production material. The using method includes the following steps: placing the hydrogen production material into a hydrogen collector filled with water at room temperature and atmospheric pressure, and enabling same to react so as to obtain hydrogen as well as recyclable reaction liquid and residue from the hydrogen collector. The hydrogen collector is made of materials with good corrosion resistance, friction resistance, and internal pressure resistance, which avoids the hydrogen collector being corroded by the sodium hydroxide in the reaction process and damaged under the action of the generated gas.

According to the present disclosure, after the hydrogen production material reacts with the water in the hydrogen collector, the collected hydrogen can be passed through a pipeline into a water storage tank to filter trace water molecules and then used for combustion in a gas boiler of a thermal power plant; and alternatively, the obtained hydrogen gas can be dehumidified through a dryer and used in other high-end fields such as medical treatment, with a wide range of uses.

The main component of the reaction solution obtained after reaction is sodium meta-aluminate (2Al+2H₂O+2NaOH=2NaAlO₂+3H₂ ↑), so that the reaction solution can be supplied to an aluminum smelter for manufacturing cryolite (Na₃AlF₆) which is a material required for aluminum smelting:

2NaAlO₂+CO₂+3H₂O=2Al(OH)₃↓+Na₂CO₃;

2Al(OH)₃+12HF+3Na₂CO₃=2Na₃AlF₆+3CO₂↑+9H₂O.

After the hydrogen production material reacts in the water and releases the hydrogen, it will be broken into residue, and the residue are weakly alkaline, which can replace part of the aluminum powder and the yellow mud as the raw material to prepare the hydrogen production material, and can also be used in paddy fields as a soil improver for recycling. Therefore, the reaction solution and residue obtained after using the hydrogen production material in the present disclosure can be recycled, so that the raw material utilization rate is high.

Preferably, in the hydrogen collector, the mass ratio of the water to the hydrogen production material is (8-12):1. When the ratio of the reactants is within this range, the temperature risen in the hydrogen collector can be controlled within 3-10° C. in the reaction process, which avoids the overhigh temperature in the hydrogen collector from affecting the reaction safety. The present disclosure further discloses a use of the obtained residue and the obtained reaction liquid in a hydrogen production material. The hydrogen production material is prepared from raw materials, and the raw materials in percentage by mass comprises: 12-17% of sodium hydroxide, 10-15% of the reaction liquid, 1-3% of a solid material capable of reacting with the sodium hydroxide to form an adhesive, 10-30% of a forming intermediate, 10-30% of aluminum powder, and 14-55% of the residue.

According to the present disclosure, the reaction liquid obtained from the use of the hydrogen production material can replace part of the sodium hydroxide and the water as the raw material for hydrogen production, and the residue obtained therefrom can replace part of yellow mud and the aluminum powder as the raw material for hydrogen production, thereby achieving the recycling of the raw materials and further reducing the cost of the hydrogen production material.

Preferably, the solid material is 3,000-mesh to 5,000-mesh hydrophilic fumed silica; the forming intermediate is yellow mud; the sodium hydroxide is industrial grade caustic soda flake; and the aluminum powder is aluminum powder waste.

The preparation method of the hydrogen production material includes the following steps: (1) adding the sodium hydroxide into the reaction liquid, stirring for dissolving and then adding the solid material, stirring until the mixture is dissolved and then adding the forming intermediate, stirring evenly and then adding the aluminum powder and the residue, and stirring evenly to obtain forming slurry; and (2) compacting the forming slurry for molding, and then drying to obtain the hydrogen production material.

The present disclosure also discloses a use of the obtained residue in a paddy field soil improver. Components of the paddy field soil improver in parts by weight includes: 1 part of dihydrate gypsum powder, 10-15 parts of the residue, and 1.5-4.5 parts of water.

The residue obtained after the use of the hydrogen production material provided by the present disclosure are weakly alkaline, in which the aluminum element exists in a form of aluminosilicate, thus being low in bioavailability and basically harmless to paddy. After the residue is mixed with the dihydrate gypsum powder to prepare the soil improver, the residue can produce trace hydrogen in the paddy field. The produced hydrogen is conducive to improving the stress resistance of the paddy, and can promote the rooting of the paddy; the produced hydrogen can also improve the resistance of the paddy to diseases and insect pests, thus being capable of replacing some pesticides; and the produced hydrogen can also reduce the consumption of chemical fertilizers, which is conducive to improving yield of paddy. The dihydrate gypsum powder contains moderate elements such as calcium and sulfur elements required by the paddy, which is beneficial to improvement of soil structure. Therefore, when the soil improver prepared by using the residue in the present disclosure is applied to the paddy fields, the consumption of the chemical fertilizers and pesticides can be reduced, soil improvement is implemented, and people's concerns about the safety of food applied with the chemical fertilizers and pesticides are overcome.

Preferably, a preparation method of the paddy field soil improver includes the following steps: firstly, mixing the dihydrate gypsum powder with the residue and stirring evenly, and then continuously adding water to mix and stir evenly in a stirring state. The soil improver prepared by the method has texture in fluffy and is easy to hold by hand. It is not allowed to soak and stir the residue and the dihydrate gypsum powder in the water, which will affect the texture of the soil improver and be unfavorable for use.

Preferably, the dosage of the paddy field soil improver in a paddy field is 0.2-0.5 kg/m 2.

Therefore, the present disclosure has the following beneficial effects.
(1) The preparation process is simple, non-toxic and pollution-free, and does not produce irritating odor, with stable product composition and good safety.
(2) The raw materials are cheap and easy to obtain, the production cost is low, and the product can be recycled, so that the present disclosure is suitable for large-scale industrial production.
(3) The hydrogen production material is convenient to transport and use, and can continuously produce hydrogen at room temperature and atmospheric pressure after being directly placed in the water.

### DESCRIPTION OF THE EMBODIMENTS

The present disclosure will be further described below in conjunction with specific embodiments.

### Example 1

A recyclable hydrogen production material was prepared from raw materials in percentage by mass comprising: 12% of sodium hydroxide (industrial grade caustic soda flake, commercially available), 22% of water from a river, 1% of hydrophilic fumed silica (3,000 meshes, commercially available), 25% of yellow mud from a mountain, and 40% of aluminum powder waste.

A preparation method of the recyclable hydrogen production material included the following steps: (1) adding the sodium hydroxide into the water, stirring for dissolving and then adding the silica, stirring until the mixture was dissolved and then adding the yellow mud, stirring evenly and then adding the aluminum powder waste, and stirring evenly to obtain forming slurry; and (2) compacting the forming slurry into a brick shape of 240 mm×115 mm×53 mm in a mold, and then naturally drying in the air to obtain the hydrogen production material, where the mold was clamped on a rotating frame and continuously turned over in the drying process.

The prepared hydrogen production material was placed in a hydrogen collector filled with water, with a mass ratio of the water in the hydrogen collector to the hydrogen production material being 10:1, and could continuously react for 48 h to produce hydrogen. After the reaction, the hydrogen, reaction liquid and residue were collected from the hydrogen collector.

### Example 2

A recyclable hydrogen production material was prepared from raw materials in percentage by mass comprising: 14% of sodium hydroxide (industrial grade caustic soda flake, commercially available), 10% of water from a well, 2% of hydrophilic fumed silica (5,000 meshes, commercially available), 39% of yellow mud from a mountain, and 35% of aluminum powder waste.

A preparation method of the recyclable hydrogen production material included the following steps: (1) adding the sodium hydroxide into the water, stirring for dissolving and then adding the silica, stirring until the mixture was dissolved and then adding the yellow mud, stirring evenly and then adding the aluminum powder waste, and stirring evenly to obtain forming slurry; and (2) compacting the forming slurry into a brick shape of 240 mm×115 mm×53 mm in a mold, and then drying in the sun to obtain the hydrogen production material, where the mold was clamped on a rotating frame and continuously turned over in the process of drying in the sun.

The prepared hydrogen production material was placed in a hydrogen collector filled with water, with a mass ratio of the water in the hydrogen collector to the hydrogen production material being 8:1, and could continuously react for 48 h to produce hydrogen. After the reaction, the hydrogen, reaction liquid and residue were collected from the hydrogen collector.

### Example 3

A recyclable hydrogen production material was prepared from raw materials in percentage by mass comprising: 15% of sodium hydroxide (industrial grade caustic soda flake, commercially available), 15% of water from a well, 1% of hydrophilic fumed silica (5,000 meshes, commercially available), 44% of yellow mud from a mountain, and 25% of aluminum powder waste.

A preparation method of the recyclable hydrogen production material included the following steps: (1) adding the sodium hydroxide into the water, stirring for dissolving and then adding the silica, stirring until the mixture was dissolved and then adding the yellow mud, stirring evenly and then adding the aluminum powder waste, and stirring evenly to obtain forming slurry; and (2) compacting the forming slurry into a brick shape of 240 mm×115 mm×53 mm in a mold, and then naturally drying in the air to obtain the hydrogen production material, where the mold was clamped on a rotating frame and continuously turned over in the drying process.

The prepared hydrogen production material was placed in a hydrogen collector filled with water, with a mass ratio of the water in the hydrogen collector to the hydrogen production material being 12:1, and could continuously react for 48 h to produce hydrogen. After the reaction, the hydrogen, reaction liquid and residue were collected from the hydrogen collector.

### Example 4

A recyclable hydrogen production material was prepared from raw materials in percentage by mass comprising: 17% of sodium hydroxide (industrial grade caustic soda flake, commercially available), 15% of water from a well, 3% of hydrophilic fumed silica (5,000 meshes, commercially available), 35% of yellow mud from a mountain, and 30% of aluminum powder waste.

A preparation method of the recyclable hydrogen production material included the following steps: (1) adding the sodium hydroxide into the water, stirring for dissolving and then adding the silica, stirring until the mixture was dissolved and then adding the yellow mud, stirring evenly and then adding the aluminum powder waste, and stirring evenly to obtain forming slurry; and (2) compacting the forming slurry into a brick shape of 240 mm×115 mm×53 mm in a mold, and then naturally drying in the air to obtain the hydrogen production material, where the mold was clamped on a rotating frame and continuously turned over in the drying process.

The prepared hydrogen production material was placed in a hydrogen collector filled with water, with a mass ratio of the water in the hydrogen collector to the hydrogen production material being 10:1, and could continuously react for 48 h to produce hydrogen. After the reaction, the hydrogen, reaction liquid and residue were collected from the hydrogen collector.

### Example 5

A recyclable hydrogen production material was prepared from raw materials in percentage by mass comprising: 12% of sodium hydroxide (industrial grade caustic soda flake, commercially available), 12% of the reaction liquid obtained from Example 1, 1% of hydrophilic fumed silica (3,000 meshes, commercially available), 10% of yellow mud from a mountain, 10% of aluminum powder waste, and 55% of the residue obtained from Example 1.

A preparation method of the recyclable hydrogen production material included the following steps: (1) adding the sodium hydroxide into the reaction liquid, stirring for dissolving and then adding the silica, stirring until the mixture was dissolved and then adding the yellow mud, stirring evenly and then adding the aluminum powder waste and the residue, and stirring evenly to obtain forming slurry; and (2) compacting the forming slurry into a brick shape of 240 mm×115 mm×53 mm in a mold, and then naturally drying in the air to obtain the hydrogen production material, where the mold was clamped on a rotating frame and continuously turned over in the drying process.

The prepared hydrogen production material was placed in a hydrogen collector filled with water, with a mass ratio of the water in the hydrogen collector to the hydrogen production material being 10:1, and could continuously react for 48 h to produce hydrogen. After the reaction, the hydrogen, reaction liquid and residue were collected from the hydrogen collector.

### Example 6

A recyclable hydrogen production material was prepared from raw materials in percentage by mass comprising: 14% of sodium hydroxide (industrial grade caustic soda flake, commercially available), 10% of the reaction liquid obtained from Example 1, 2% of hydrophilic fumed silica (3,000 meshes, commercially available), 30% of yellow mud from a mountain, 30% of aluminum powder waste, and 14% of the residue obtained from Example 1.

A preparation method of the recyclable hydrogen production material included the following steps: (1) adding the sodium hydroxide into the reaction liquid, stirring for dissolving and then adding the silica, stirring until the mixture was dissolved and then adding the yellow mud, stirring evenly and then adding the aluminum powder waste and the residue, and stirring evenly to obtain forming slurry; and (2) compacting the forming slurry into a brick shape of 240 mm×115 mm×53 mm in a mold, and then naturally drying in the air to obtain the hydrogen production material, where the mold was clamped on a rotating frame and continuously turned over in the drying process.

The prepared hydrogen production material was placed in a hydrogen collector filled with water, with a mass ratio of the water in the hydrogen collector to the hydrogen production material being 10:1, and could continuously react for 48 h to produce hydrogen. After the reaction, the hydrogen, reaction liquid and residue are collected from the hydrogen collector.

### Example 7

A recyclable hydrogen production material was prepared from raw materials in percentage by mass comprising: 17% of sodium hydroxide (industrial grade caustic soda flake, commercially available), 15% of the reaction liquid obtained from Example 1, 3% of hydrophilic fumed silica (3,000 meshes, commercially available), 10% of yellow mud from a mountain, 30% of aluminum powder waste, and 25% of the residue obtained from Example 1.

A preparation method of the recyclable hydrogen production material includes the following steps: (1) adding the sodium hydroxide into the reaction liquid, stirring for dissolving and then adding the silica, stirring until the mixture was dissolved and then adding the yellow mud, stirring evenly and then adding the aluminum powder waste and the residue, and stirring evenly to obtain forming slurry; and (2) compacting the forming slurry into a brick shape of 240 mm×115 mm×53 mm in a mold, and then naturally drying in the air to obtain the hydrogen production material, where the mold was clamped on a rotating frame and continuously turned over in the drying process.

The prepared hydrogen production material was placed in a hydrogen collector filled with water, with a mass ratio of the water in the hydrogen collector to the hydrogen production material being 10:1, and could continuously react for 48 h to produce hydrogen. After the reaction, the hydrogen, reaction liquid and residue were collected from the hydrogen collector.

### Comparative Example 1

A recyclable hydrogen production material was prepared from raw materials in percentage by mass comprising: 12% of sodium hydroxide (industrial grade caustic soda flake, commercially available), 30% of water from a river, 1% of hydrophilic fumed silica (3,000 meshes, commercially available), 25% of yellow mud from a mountain, and 32% of aluminum powder waste. A preparation method of the recyclable hydrogen production material was the same as that in Example 1.

The prepared hydrogen production material was placed in a hydrogen collector filled with water, with a mass ratio of the water in the hydrogen collector to the hydrogen production material being 10:1, and could continuously react for 36 h to produce hydrogen. After the reaction, the hydrogen, reaction liquid and residue were collected from the hydrogen collector.

### Comparative Example 2

The difference between Comparative Example 2 and Example 1 was that during the preparation process of the hydrogen production material, in step (2), the mold was placed horizontally for natural air drying without being turned over. The remainder of Comparative Example 2 was the same as that in Example 1.

The prepared hydrogen production material was placed in a hydrogen collector filled with water, with a mass ratio of the water in the hydrogen collector to the hydrogen production material being 10:1, and could continuously react for 42 h to produce hydrogen. After the reaction, the hydrogen, reaction liquid and residue were collected from the hydrogen collector.

As can be seen from the above-mentioned examples and comparative examples, the hydrogen production material prepared by the method of the present disclosure in Examples 1-4 could react with the water at room temperature and atmospheric pressure for 48 h continuously to produce hydrogen, with an even gas production rate, and the use method was simple. Moreover, in Examples 5-7, the residue obtained after the use of the hydrogen production material in Example 1 are used as the raw material, and after the hydrogen production material was continued to be prepared, the hydrogen could still be continuously produced for 48 h, so that the recycling of the raw material could be realized.

Since the hydrogen production material in Comparative Example 1 was prepared with too much water, excessive consumption of the aluminum powder in the reaction with the water would be caused in the preparation process, resulting in a significant reduction in the hydrogen production time during the use of the hydrogen production material compared with that in Example 1. In Comparative Example 2, the hydrogen production material was not turned over in the drying process, and the hydrogen production time during use was also reduced somewhat compared with Example 1, which might be due to the fact that the hydrogen production material was not turned over in the drying process, resulting in more pores in the surface of the hydrogen production material and fewer pores in the bottom thereof, and uneven distribution of pore structures; the more pores in the surface would lead to a large contact area between the material and the water, which accelerated the hydrogen production rate, while the fewer pores in the bottom would cause part of the aluminum powder to be unable to effectively contact with the water, which reduced the material utilization, thus ultimately shortening the hydrogen production time.

Use Example 1

Taking the soil in the south of Xiaoshan District in Hangzhou as an example, the residue obtained from Example 1 were used for preparing a paddy field soil improver, and the method included the following steps:
(1) tidying up a paddy field for flattening, clearing away weeds, injecting straw weeds into the paddy field as organic fertilizer, and then planting rice seedlings;
(2) mixing 1 kg of dihydrate gypsum powder and 10 kg of the residue obtained from Example 1, stirring evenly and then continuously adding 2.5 kg of water in a stirring state, and mixing and stirring evenly to obtain a paddy field soil improver;
(3) after the rice seedlings are planted for 10 days, evenly applying the above-mentioned paddy field soil improver at a dosage of 0.5 kg/m 2 to the paddy field;
(4) carrying out conventional irrigation during the growth of the rice seedlings; if there are pests, boiling pod pepper or millet pepper in water, and spraying the boiled water onto leaf surfaces to repel the pests;
(5) before rice heading, evenly applying the paddy field soil improver at a dosage of 0.25 kg/m 2 to the paddy field; and
(6) carrying out daily maintenance and irrigation until the rice was mature.

By adopting the above method, the consumption of chemical fertilizers and pesticides can be reduced, and people's concerns about the safety of food applied with the chemical fertilizers and pesticides are overcome.

1. A recyclable hydrogen production material, prepared from raw materials, the raw materials in percentage by mass comprising:
12-17% of sodium hydroxide,
10-22% of water,
1-3% of a solid material capable of reacting with the sodium hydroxide to form an adhesive,
25-44% of a forming intermediate, and
25-40% of aluminum powder.

2. The hydrogen production material according to claim 1, wherein
the solid material is 3,000-mesh to 5,000-mesh hydrophilic fumed silica;
the forming intermediate is yellow mud;
the water is selected from one or more of water from a well, water from a mountain, and water from a river;
the sodium hydroxide is industrial grade caustic soda flake; and
the aluminum powder is aluminum powder waste.

3. A preparation method of the hydrogen production material according to claim 1, comprising the following steps:
(1) adding the sodium hydroxide into the water, stirring for dissolving and then adding the solid material, stirring until the mixture is dissolved and then adding the forming intermediate, stirring evenly and then adding the aluminum powder, and stirring evenly to obtain forming slurry; and
(2) compacting the forming slurry for molding, and then drying to obtain the hydrogen production material.

4. A method of using the hydrogen production material according to claim 1, comprising the following steps:
placing the hydrogen production material into a hydrogen collector filled with water at a room temperature and an atmospheric pressure, and
enabling same to react so as to obtain hydrogen as well as recyclable reaction liquid and a residue from the hydrogen collector.

5. The method according to claim 4, wherein a mass ratio of the water to the hydrogen production material in the hydrogen collector is (8-12):1.

6. A method of using the residue and the recyclable reaction liquid obtained from claim 4 in a hydrogen production material, wherein the hydrogen production material is prepared from raw materials, and the raw materials in percentage by mass comprises:
12-17% of sodium hydroxide,
10-15% of the recyclable reaction liquid,
1-3% of a solid material capable of reacting with the sodium hydroxide to form an adhesive,
10-30% of a forming intermediate,
10-30% of aluminum powder, and
14-55% of the residue.

7. The method according to claim 6, wherein
the solid material is 3,000-mesh to 5,000-mesh hydrophilic fumed silica;
the forming intermediate is yellow mud;
the sodium hydroxide is industrial grade caustic soda flake; and
the aluminum powder is aluminum powder waste.

8. A preparation method of the hydrogen production material according to claim 6, comprising the following steps:
(1) adding the sodium hydroxide into the reaction liquid, stirring for dissolving and then adding the solid material, stirring until the mixture is dissolved and then adding the forming intermediate, stirring evenly and then adding the aluminum powder and the residue, and stirring evenly to obtain forming slurry; and
(2) compacting the forming slurry for molding, and then drying to obtain the hydrogen production material.

9. A method of using the residue obtained from claim 4 in a paddy field soil improver, wherein components of the paddy field soil improver in parts by weight comprises:
1 part of dihydrate gypsum powder,
10-15 parts of the residue, and
1.5-4.5 parts of water.

10. The method according to claim 9, wherein a dosage of the paddy field soil improver in a paddy field is 0.2-0.5 kg/m².

11. A preparation method of the hydrogen production material according to claim 2, comprising the following steps:
(1) adding the sodium hydroxide into the water, stirring for dissolving and then adding the solid material, stirring until the mixture is dissolved and then adding the forming intermediate, stirring evenly and then adding the aluminum powder, and stirring evenly to obtain forming slurry; and
(2) compacting the forming slurry for molding, and then drying to obtain the hydrogen production material.

12. A method of using the hydrogen production material according to claim 2, comprising the following steps:
placing the hydrogen production material into a hydrogen collector filled with water at a room temperature and an atmospheric pressure, and
enabling same to react so as to obtain hydrogen as well as recyclable reaction liquid and a residue from the hydrogen collector.

13. A preparation method of the hydrogen production material according to claim 7, comprising the following steps:
(1) adding the sodium hydroxide into the reaction liquid, stirring for dissolving and then adding the solid material, stirring until the mixture is dissolved and then adding the forming intermediate, stirring evenly and then adding the aluminum powder and the residue, and stirring evenly to obtain forming slurry; and
(2) compacting the forming slurry for molding, and then drying to obtain the hydrogen production material.
